(19) United States
(12) Patent Application Publication
(10) Pub. No.: US 2008/0061107 A1
(43) Pub. Date: Mar. 13, 2008

(54) Stapler

(76) Inventors: Toshio Shimizu, Tokyo (JP); Kazuhiko Kishi, Tokyo (JP); Katsuya Hakozaki, Tokyo (JP); Kazuo Higuchi, Tokyo (JP)

Correspondence Address: MORGAN LEWIS & BOCKIUS LLP, 1111 PENNSYLVANIA AVENUE NW, WASHINGTON, DC, 20004, US

(21) Appl. No.: 11/632,071

(22) PCT Filed: Jul. 6, 2005
(86) PCT No.: PCT/JP05/12499

§ 371 Date: Jan. 10, 2007

(30) Foreign Application Priority Data
Jul. 15, 2004 (JP) 2004-208413

(51) Int. Cl. B25C 5/02; B27F 7/19

(52) U.S. Cl. 227/134

(57) ABSTRACT

An operating frame is pivotably held by a clincher frame by way of a fulcrum shaft on a rear end side thereof. A front end side of the operating frame is formed with an operating plate. The operating plate is engaged with a movable clincher. The movable clincher is operated by pivoting the operating frame centering on the fulcrum shaft. A drive link is engaged with the operating frame. The movable clincher is operated by way of the operating frame pivoted by operating the drive link. Further, the fulcrum shaft of the operating frame is urged by a spring by a load compatible with a predetermined clinch load.

### TECHNICAL FIELD

The present invention relates to a stapler including a strike mechanism for striking a staple formed in a C-shape to sheets (sheets of paper to be bound), and a movable clincher engaged with a staple leg penetrated to a back face side of the sheets for folding to bend a staple leg along the back face of the sheets.

### BACKGROUND ART

According to an electric stapler for striking a staple to sheets to bundle to bind a plurality of the sheets by the staple, the staple in a C-shape including a pair of leg portions is struck to the sheets by a strike mechanism, and the pair of staple legs penetrated to a back face side of the sheets are folded to bend along the back face of the sheets by a clincher mechanism. According to a certain kind of an electric stapler, a clincher mechanism is constituted by a pair of movable clinchers provided pivotably to be opposed to respective stapler legs penetrated to a back face side of sheets. The staple is bound by finishing to penetrate almost all portions of the staple legs of the staple struck out from the strike mechanism portion and thereafter operating to pivot the movable clincher to be engaged with the staple legs to thereby bend the staple legs.

The pair of movable clinchers are provided to be respectively axially supported pivotably between two clincher guide plates aligned in a front and rear direction to be opposed to a position of striking out the staple. A clinch face to be engaged with the staple leg is arranged in correspondence with a position of the staple leg penetrated to the back face side of the sheets. By operating to pivot the movable clincher around the fulcrum shaft, the clinch face is engaged with the staple leg to bend the staple leg along the back face of the sheet. In order to operate to pivot the movable clincher, there is provided a drive link a center portion of which is pivotably supported by a frame, and the movable clincher is pivoted by operating to pivot a front end portion of the drive link in an up and down direction by engaging a rear portion of the drive link with a drive cam driven to rotate by an electric motor for driving the stapler and engaging a front end portion of the drive link with a portion of the movable clincher. (Refer to, for example, JP-A-10-128683)

The movable clincher is operated to pivot by the drive link in a range of an operating stroke thereof, and is operated to pivot to press to form the staple leg to be brought into close contact with the sheets along the back face of the sheets by engaging the clinch face of the movable clincher with the staple leg. According to a mechanism for operating the movable clincher of the kind, the movable clincher is operated to pivot by the drive link swung by the drive cam, and an amount of the operating stroke of the drive link and an amount of the operating stroke of the movable clincher are made to coincide with each other. Therefore, when the amount of the pivoting stroke of the front end portion of the drive link is varied or the range of the operating stroke is shifted by accumulating dimensional tolerances of parts of the drive link, the drive cam and the like, the operating stroke of the clincher operated by the drive link is varied, and a clinch load on the staple leg by the movable clincher is varied.

When the clinch load of the movable clincher operated by the drive link is varied by varying the amount of operating the drive link, an amount of pressing the staple leg by the clinch face becomes excessively small and clinching is carried out in a state of floating the staple leg from the back face of the sheets, or the amount of pressing the staple leg by the clinch face becomes excessively large and the needle is detached from the clincher, or in a case of thin sheet, the sheets are broken. Further, when the movable clincher is excessively protruded, there is a case in which the sheets cannot be moved in carrying the sheets by jamming the sheets to the movable clincher and therefore, according to a staple of a certain other kind, a portion of the movable clincher is brought into contact with the frame, and a final operating portion of the clincher is restricted. However, according to such a mechanism, a large load is produced at the motor or the like by varying an amount of operating a drive link by tolerances of parts or the like.

### DISCLOSURE OF THE INVENTION

One or more embodiments of the invention provide a stapler including a mechanism of operating a movable clincher for maintaining a clinching shape of a staple leg by the movable clincher in a stable state by maintaining a clinch load of the movable clincher by a pertinent load.

In accordance with one or more embodiments of the invention, there is provided a stapler in which a mechanism of driving a movable clincher of the stapler is constituted by including a strike mechanism portion for striking out a staple formed in a C-shape to a sheet, a pair of movable clinchers including clinch faces capable of being engaged with staple legs of the staple struck out from the strike mechanism portion to be penetrated through the sheet, and a drive link operated by a drive mechanism of driving the stapler by operating the movable clinchers, the staple legs are folded to bend along a face of the sheet by the movable clinchers driven by way of the drive link, characterized in that there is provided an operating frame a rear end side of which is pivotably held by a clincher frame for supporting the movable clinchers and the drive link by way of a fulcrum shaft, the movable clinchers are operated by pivoting the operating frame centering on the fulcrum shaft by engaging an operating plate formed on a front end side of the operating frame with the movable clinchers, the movable clinchers are operated by way of the operating frame pivoted by operating the drive link by engaging the drive link with the operating frame, further, the fulcrum shaft of the operating frame is pivotably supported by the clincher frame, and the fulcrum shaft is arranged at an end portion of a pivoting range by a load urged by a spring compatible with a clinch load.

In accordance with one or more embodiments of the invention, the clincher frame is provided with the operating frame the rear end side of which is pivotably held by the clincher frame by way of the fulcrum shaft, the movable clincher is operated by pivoting the operating frame centering on the fulcrum shaft by engaging the operating plate formed at the front end side of the operating frame with the movable clincher, the movable clincher is operated by way of the operating frame pivoted by operating the drive link by engaging the drive link with the operating frame, further, the fulcrum shaft of the operating frame is pivotably supported by the clincher frame, the fulcrum shaft is arranged at the end portion in the pivoting range by the load urged by the spring compatible with the clinch load and therefore, when operated to exert the predetermined clinch load to the staple leg by the movable clincher in the state of bending the staple leg by engaging the clincher face of the movable clincher operated by way of the operating frame with the staple leg, the side of the operating frame is pivoted by an urge force by the fulcrum spring, thereby, the clinch load equal to or larger than the predetermined load is prevented from being operated to the movable clincher by way of the drive link. Therefore, it can be prevented that the staple leg is floated up or the sheet is broken by operating the clincher always up to a constant load without effecting an influence on the clinch load of the movable clincher by a variation in an operating stroke of the drive link, and the clincher can be operated in a state in which the clinch shape of the staple leg is stable.

In accordance with one or more embodiments of the invention, a stapler includes a clincher frame, a movable clincher supported by the clincher frame, a drive link supported by the clincher frame, an operating frame a rear end side of which is pivotably held by way of a fulcrum shaft and which is operated by operating the drive link, and an operating plate provided on a front end side of the operating frame for operating the movable clincher in accordance with rotation of the operating frame. The fulcrum shaft is pivotably supported by the clincher frame.

In accordance with one or more embodiments of the invention, the stapler includes a spring for urging the fulcrum shaft in a direction of an end portion of a pivoting range.

In accordance with one or more embodiments of the invention, the stapler includes an elongated hole provided at the clincher frame and loosely fitted with the fulcrum shaft.

In accordance with one or more embodiments of the invention, the stapler includes a strike mechanism portion for striking out a staple formed in a C-shape to a sheet, and a single electric motor. The movable clincher and the strike mechanism portion are operated based on driving the single electric motor.

Other aspects and advantages of the invention will be apparent from the following description and the appended claims.

### BRIEF DESCRIPTION OF THE DRAWINGS

FIG. 1 is a side view of an electric motor according to one or more embodiments.

FIG. 2 is a perspective view showing a clincher mechanism portion.

FIG. 3 is a vertical sectional side view of the clincher mechanism portion.

FIG. 4 is a perspective view vertically cutting to show the clincher mechanism portion.

FIG. 5 is a front view of an essential portion of the clincher mechanism portion showing a state in which a movable clincher is not operated.

FIG. 6 is a front view of the essential portion of the clincher mechanism portion showing the state in which the movable clincher is not operated.

FIG. 7 is a vertical sectional side view of a main part showing an operating state in which the movable clincher is not operated.

FIG. 8 is a perspective view of the main part in a state the same as that of FIG. 7.

FIG. 9 is a vertical sectional side view of the main part showing an operating state in which the movable clincher is being operated.

FIG. 10 is a perspective view of the main part in a state the same as that of FIG. 9.

FIG. 11 is a vertical sectional side view of the main part showing a state in which the movable clincher is operated up to a predetermined clinch load.

FIG. 12 is a perspective view of the main part in a state the same as that of FIG. 11.

### DESCRIPTION OF REFERENCE NUMERALS AND SIGNS

1 . . . stapler

7 . . . clincher mechanism portion

8 . . . clincher frame

9 . . . movable clincher

10 . . . operating frame

14 . . . fulcrum spring

15 . . . drive link

17 . . . drive shaft

19 . . . operating plate

### BEST MODE FOR CARRYING OUT THE INVENTION

One or more embodiments of the invention will be explained in reference to the drawings as follows.

### Embodiment 1

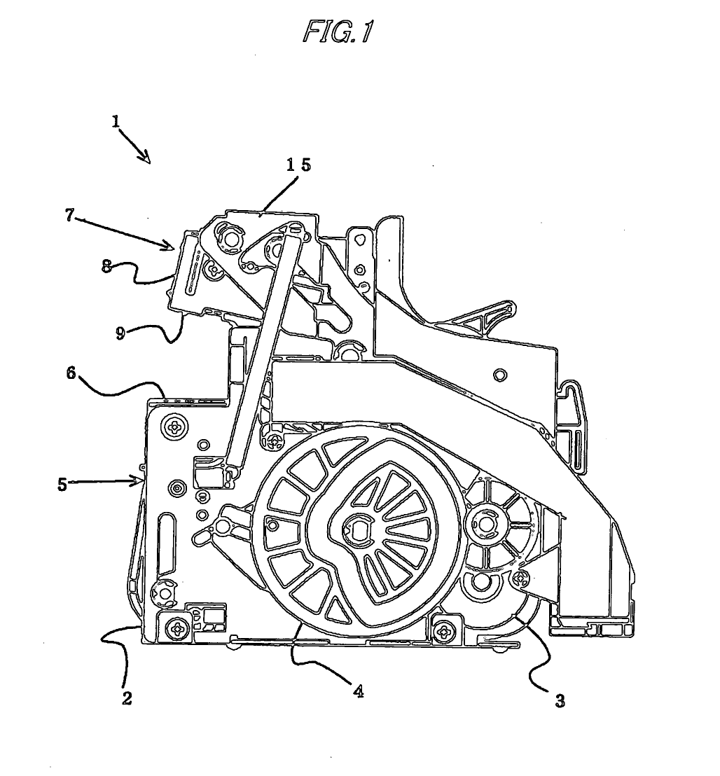

FIG. 1 shows a stapler 1 according to one or more embodiments of the invention. The stapler 1 is an electric stapler installed in a copier, a printer or the like for automatically binding sheets subjected to a copying process or a printing process by being driven by an electric motor. The stapler 1 contains an electric motor 3, a reduction gear mechanism and the like at inside of a machine frame 2 forming an outer frame of the stapler 1, and a drive cam 4 driven to rotate by the electric motor 3 by way of the reduction gear mechanism is arranged at a side face of the machine frame 2. A lower portion of the machine frame 2 is formed with a strike mechanism portion 5 driven by the drive cam 4 for striking out a staple formed in a C-shape to sheets. The striking mechanism portion 5 is constituted to strike out the staple in the C-shape to sheets arranged above an upper face of a table 6 formed above the strike mechanism portion 5 in an upper direction.

Further, an upper portion of the machine frame 2 opposed to the upper face of the table 6 is formed with the clincher mechanism portion 7 for folding to bend a staple leg penetrated to a side of the upper face of the sheet mounted above the table 6 along the upper face of the sheets. The clincher mechanism portion 7 includes the clincher frame 8 a rear end portion of which is pivotably supported by the machine frame 2 to be able to make a front end portion thereof proximate to and remote from the upper face of the table 6, and is constituted by a pair of the movable clinchers 9 engaged with the staple leg penetrated to a side of the upper face of the sheets mounted above the table 6 for bending the staple leg along a surface of the sheets, the operating frame 10 for operating the movable clinchers 9, and the drive link 15 driven by the drive cam 4 for operating to pivot the operating frame 10 at inside of the clincher frame 8.

The clincher mechanism portion 7 is operated to pinch the sheets above the table 6 by a lower face of the clincher frame 8 from a standby position shown in FIG. 1 after supplying the sheets to above the table 6 formed above the strike mechanism portion 5, and is thereafter operated such that the staple is struck to the sheets mounted above the table 6 from a lower face side thereof by driving the strike mechanism portion 5, further, after binding the sheets by bending the staple leg penetrated through the sheets along the upper face of the sheet by the movable clincher 9 of the clincher mechanism portion 7, the clincher mechanism portion 7 is operated again in a direction of being remote from the table 6 to return to an initial position shown in FIG. 1.

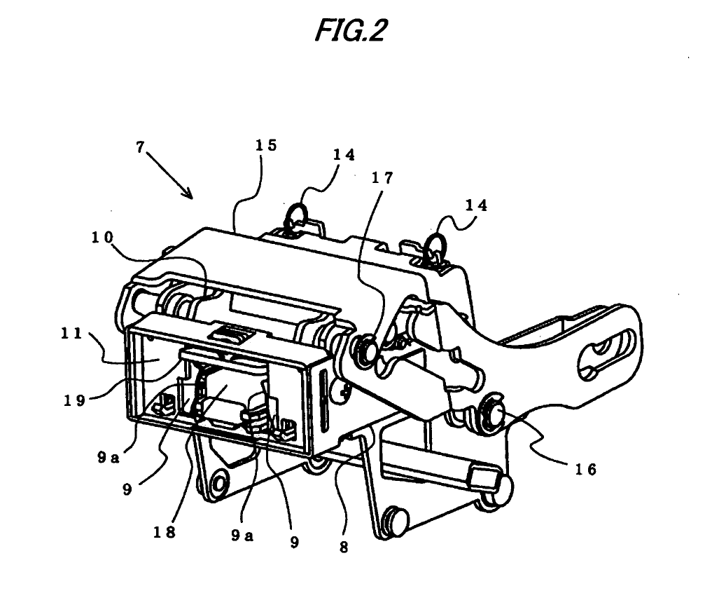

As shown by FIG. 2, the clincher frame 8 holding the movable clincher 9 includes a pair of guide plates 11 mounted to a front end of the clincher frame 8 at an interval therebetween along the front and rear direction, and the pair of movable clinchers 9 formed in a plate-like shape between the pair of guide plates 11 are pivotably held opposedly to both sides. Respective clinch faces 9a formed at lower end faces of the pair of movable clinchers 9 are arranged to be respectively opposed to staple legs struck out from the strike mechanism portion 5 to be penetrated to the upper face of the sheets.

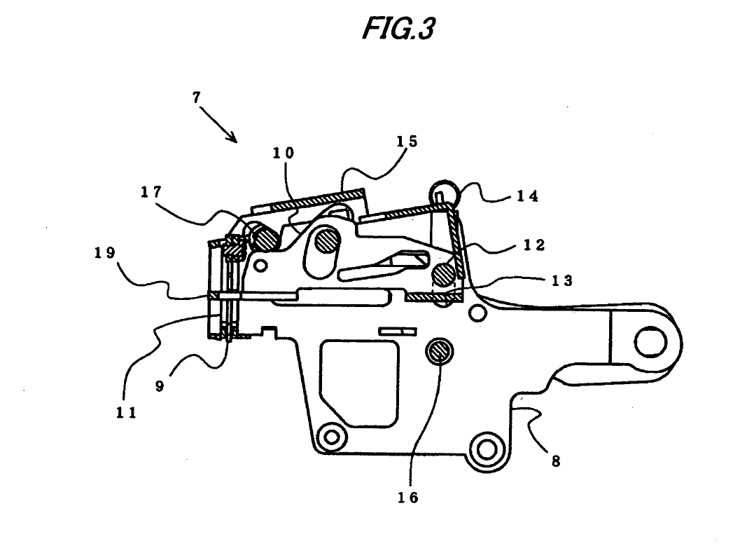

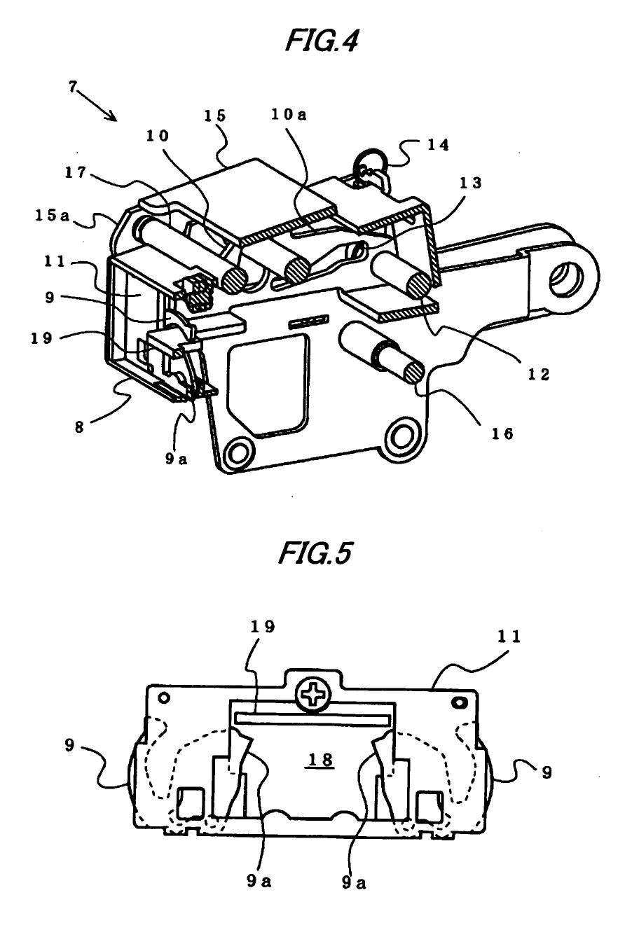

As shown by FIG. 3 and FIG. 4, according to the operating frame 10 for operating the pair of movable clinchers 9, a fulcrum shaft 12 penetrating rear end portions of side walls 10a formed on both sides of the operating frame 10 is loosely fitted into elongated holes 13 formed at both side walls of the clincher frame 8 and formed to be prolonged substantially in an up and down direction, and the fulcrum shaft 12 is supported by being urged by a spring to be arranged at upper end positions of the elongated hole 13 by way of the fulcrum springs 14 in normal time. Therefore, the operating frame 10 can be moved to pivot centering on the fulcrum shaft 12 and the fulcrum shaft 12 can be moved to pivot along the elongated holes 13 against a spring urge force by the fulcrum springs 14. A spring load by the fulcrum springs 14 is set to a load compatible with a pertinent clinch load by the movable clinchers 9 as mentioned later.

Further, the clincher mechanism portion 7 is provided with the drive link 15 for operating to pivot the operating frame 10 centering on the fulcrum shaft 12. The drive link 15 is supported by a side face of the clincher frame 8 by a pivoting support shaft 16 substantially at a center portion thereof, and is operated to pivot by the drive cam 4 centering on the pivoting support shaft 16. The drive link 15 includes side walls 15a arranged on both sides of the clincher frame 8, and the drive shaft 17 for operating to pivot the operating frame 10 by being engaged with upper end edges of the two side walls 10a of the operating frame 10 is held at an end portion on a front side between the both side walls 15a. The drive shaft 17 is operated by pivoting the drive link 15 centering on the pivoting support shaft 16, and the drive shaft 17 presses upper end edges of the two side walls 10a of the operating frame 10 to the lower side to press the operating frame 10 in the lower direction to thereby operate to pivot the operating frame 10 centering on the fulcrum shaft 12.

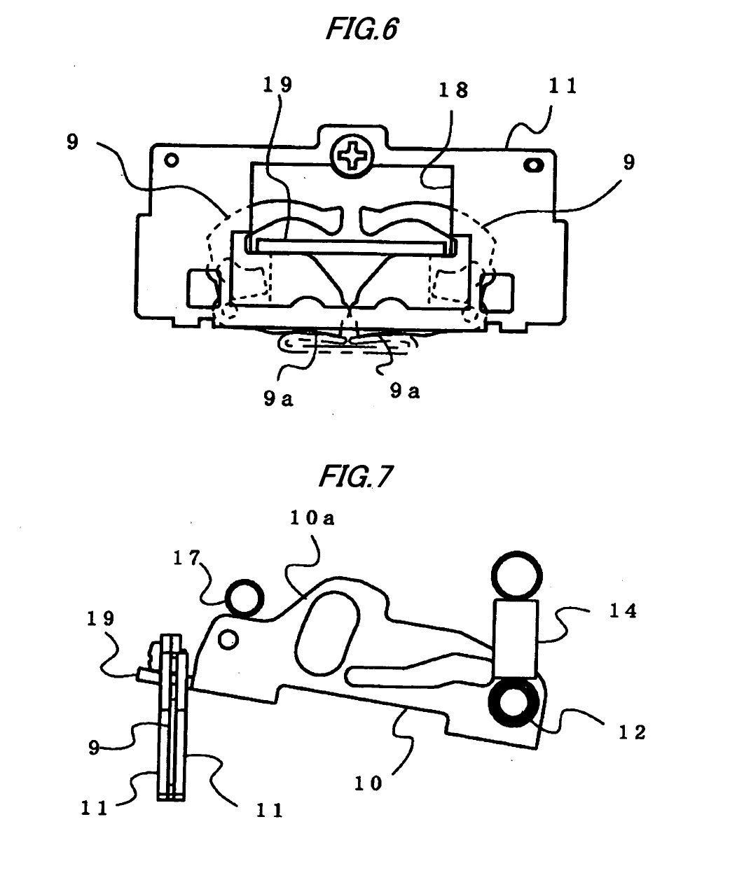

As shown by FIG. 3 and FIG. 5, the guide plate 11 is formed with an opening 18 at a center portion thereof, and a portion of the movable clincher 9 pivotably held between a pair of the guide plates 11 is arranged to be exposed at inside of the opening 18. Further, a front end portion of the operating frame 10 is formed with the operating plate 19 arranged at inside of the opening 18, and the operating plate 19 is engaged with a portion of the movable clincher 9 at inside of the opening 18 of the guide plate 11. Further, as shown by FIG. 6, the operating frame 10 is pivoted centering on the fulcrum shaft 12 by way of the drive shaft 17 of the drive link 15, by operating the operating plate 19 from the upper side to the lower side at inside of the opening 18 thereby, the operating plate 19 is engaged with the movable clincher 9 to operate to pivot the movable clincher 9 to thereby bend the staple leg.

As shown by FIG. 3, the rear end portion of the operating frame 10 is supported by loosely fitting the fulcrum shaft 12 to inside of the elongated hole 13 of the clincher frame 8 and arranging the fulcrum shaft 12 at an upper position of the elongated hole 13 by the fulcrum spring 14, further, the operating plate 19 formed at the front end of the operating frame 10 is engaged with the movable clincher 9 pivotably held by the guide plate 11. Further, the drive shaft 17 of the drive link 15 is set to be engaged with the upper end edge of the sidewall 10a between the fulcrum shaft 12 and the operating plate 19. An operating load in the lower direction transmitted to the operating frame 10 by way of the drive shaft 17 by operating the drive link 15 is operated to the operating plate 19 and the fulcrum shaft 12 by being divided to a load for operating the movable clincher 9 by way of the operating plate 19 and a load of pressing the fulcrum shaft 12 to the lower side by a lever ratio.

A side of the fulcrum shaft 12 is urged by a spring in the upper direction by the fulcrum spring 14, a spring load of the fulcrum spring 14 is set such that the fulcrum shaft 12 of the operating frame 10 is operated in the lower direction against the urge force of the fulcrum spring 14 when the movable clincher 9 operated by the operating plate 19 is exerted with a predetermined clinch load. Therefore, until the clinch load of the movable clincher 9 becomes a predetermined magnitude, the movable clincher 9 operates the operating plate 19 in the lower direction by pivoting the operating frame 10 centering on the fulcrum shaft 12 by a press force in the lower direction of the drive shaft 17. When the load of operating the movable clincher 9 is increased to exceed the predetermined clinch load, by operating the fulcrum shaft 12 of the operating frame 10 in the lower direction against the spring force of the fulcrum spring 14, the load of operating the movable clincher 9 by the drive shaft 17 is escaped.

An explanation will be given of a state of operating the movable clincher driving mechanism according to the embodiment as follows. Before operating the clincher mechanism portion 7, since the drive link 15 is not operated, also the drive shaft 17 is not operated and therefore, as shown by FIG. 7 and FIG. 8, the fulcrum shaft 12 penetrating the rear end portion of the operating frame 10 is arranged at an upper end position of the elongated hole 13 by the urge force of the fulcrum spring 14. Further, the operating frame 10 is arranged at a position pivoted in the clockwise direction centering on the fulcrum shaft 12 by an operating mechanism, not illustrated, thereby, the operating plate 19 formed integrally with the front end of the operating frame 10 is arranged on an upper side of inside of the opening 18 of the guide plate 11, and the operating plate 19 and the movable clincher 9 are not engaged. Therefore, the respective clinch faces 9a of the pair of movable clinchers 9 are pivoted to positions arranged in a state of being remote from each other.

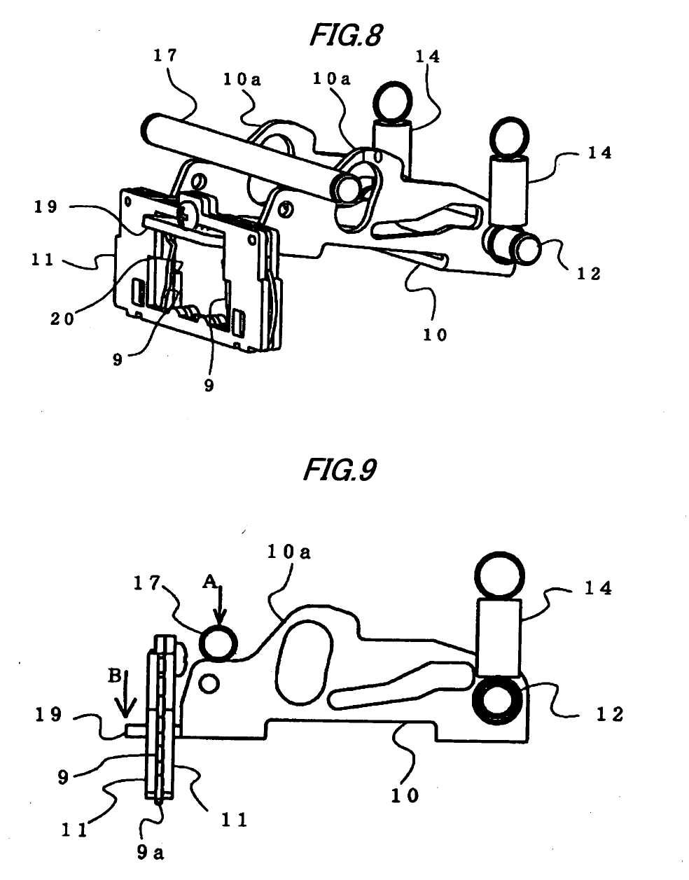

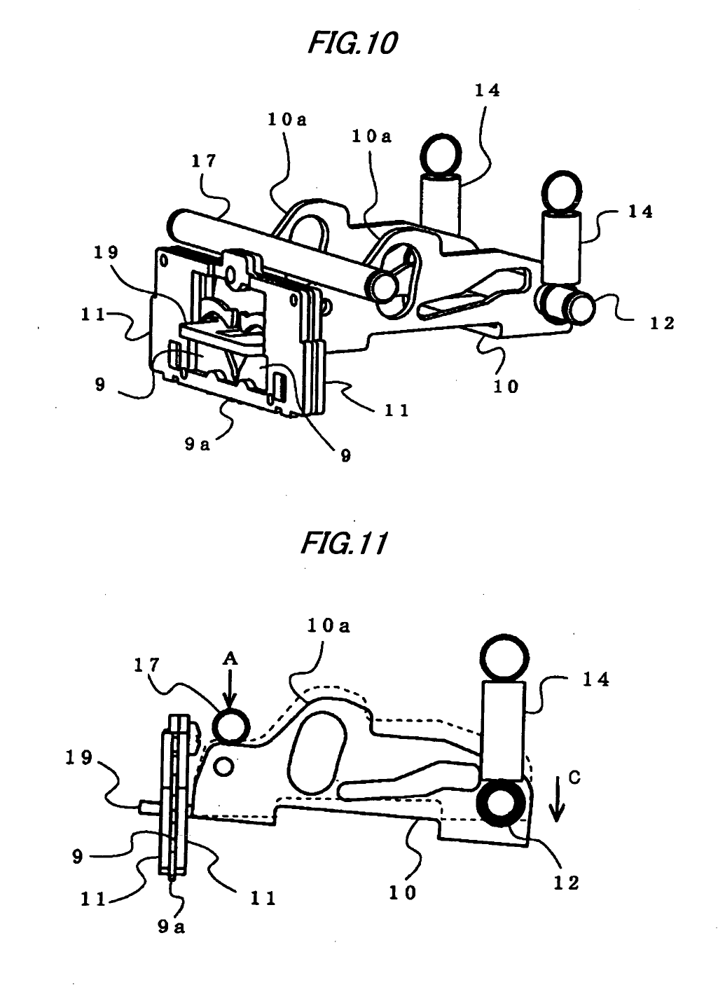

After striking the staple legs to be penetrated through the sheet to the respective clinch faces 9a of the pair of movable clinchers 9 arranged at the positions remote from each other as mentioned above, when the drive shaft 17 is operated by way of the drive link 15, the drive shaft 17 driven in the lower direction as indicated by an arrow mark A in FIG. 9 is engaged with the upper end edge of the side wall 10a of the operating frame 10 to pivot the operating frame 10 in a direction of an arrow mark B centering on the fulcrum shaft 12. Thereby, the operating plate 19 formed at the front end of the operating frame 10 is operated from the upper side to the lower side at inside of the opening 18 of the guide plate 11, the pair of movable clinchers 9 are engaged with the operating plate 19 operated at inside of the opening 18 to operate to pivot the movable clinchers 9, and the clinch faces 9a formed at movable clinchers 9 are engaged with the staple legs to bend the staple legs along the upper face of the sheet to thereby bind the staple.

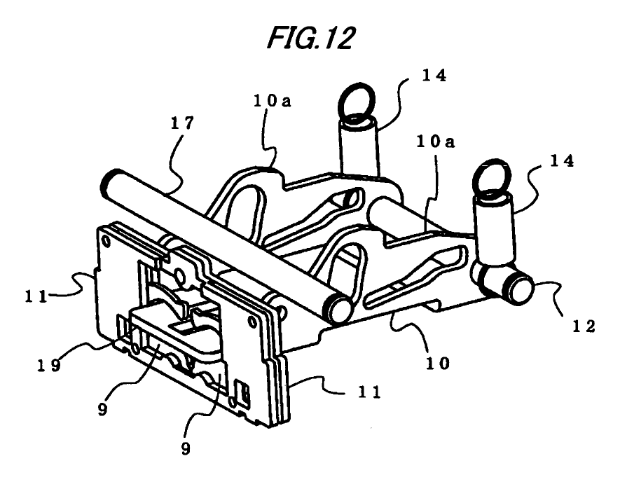

In clinching the staple by the movable clinchers 9, a clinched shape of the staple legs can be constituted by a staple shape by bending the staple legs along the upper face of the sheet by engaging the clinch faces 9a of the movable clinchers 9 with the staple legs penetrated through the sheet and pressing the staple legs to the face of the sheet by the clinch faces 9a by a predetermined clinch load. By setting the spring load of the fulcrum spring 14 for urging the fulcrum shaft 12 of the operating frame 10 for operating the movable clinchers 9 in the upper direction to a load compatible with the clinch load, as shown by FIG. 11 and FIG. 12, when the movable clincher 9 is operated to the predetermined clinch load by the operating plate 19 formed at the front end of the operating frame 10, by further operating the drive shaft 17 in the arrow mark A direction, the side of the fulcrum shaft 12 of the operating frame 10 is pivoted in a direction of an arrow mark C against the spring load of the fulcrum spring 14, and a load exceeding the predetermined clinch load operated to the movable clinchers 9 by way of the drive link 15 is prevented from being operated.

According to the movable clincher drive mechanism of the embodiment, the fulcrum shaft 12 for pivotably supporting the operating frame 10 for operating the movable clinchers 9 is constituted by being urged by the fulcrum springs 14 of the load compatible with the clinch load of the movable clinchers, the movable clinchers 9 are operated by the drive link 15 by way of the operating frame 10 and therefore, even when the operating stroke of the drive link 15 is increased by variations in tolerances of parts or the like, after operating the clinch load of the movable clinchers 9 operated by way of the drive link 15 to the predetermined load, by moving the fulcrum shaft 12 of the operating frame 10 operated by the drive link 15 against the urge force of the fulcrum springs 14, extra load transmitted to the side of the movable clinchers 9 by way of the drive link 15 is absorbed by the fulcrum springs 14 and therefore, the staple legs are not pressed more than necessary by the clinch faces 9a by the variations in the tolerances of parts or the like, the staple legs are not clinched in a state of being floated from the face of the sheet by making a press amount insufficient.

Further, as shown by FIG. 8, a projected portion 20 is formed at the guide frame 11 and the operating plate 19 for operating the movable clincher 9 is constituted to be brought into contact with the projected portion 20, even when it is prevented that the clinch face 9a of the movable clincher 9 is excessively extruded from the face of the table 6 and the sheet is caught by the movable clincher 9 when the sheet is carried, the side of the fulcrum shaft of the operating frame 10 can be pivoted even when the operating plate 19 is engaged with the projected portion 20 to hamper from being operated in the lower direction and therefore, thereby, it can be prevented that the electric motor is locked or brought into an overload state by hampering the drive link 15 from being pivoted.

Further, although an explanation has been given by the operating frame 10, even when a shape thereof is not necessarily constituted by the frame shape but by a C-shape which is not coupled with the side of the fulcrum shaft 12, there may be constructed a constitution in correspondence with a portion of receiving the drive shaft 17 and a portion of the operating plate 19 for pressing the movable clincher 9 and the elongated hole 13 arranged with the fulcrum shaft 12.

Although an explanation has been given of the invention in details and in reference to the specific embodiments, it is apparent for the skilled person that the invention can variously be changed or modified without deviating from the spirit and the range of the invention.

The application is based on Japanese Patent Application (Japanese Patent Application No. 2004-208413) filed on Jul. 15, 2004 and the contents of which are incorporated herein by reference.

### INDUSTRIAL APPLICABILITY

The stapler of the invention can be embodied not only in a stapler included in a printer, a copier or the like explained in the embodiment but also in a stapler used by itself on a table or the like.

1. A stapler comprising:
a clincher frame;
a movable clincher supported by the clincher frame;
a drive link supported by the clincher frame;
an operating frame, wherein a rear end side of the operating frame is pivotably held by the clincher frame by way of a fulcrum shaft, and the operating frame is operated by operating the drive link; and
an operating plate provided on a front end side of the operating frame for operating the movable clincher in accordance with rotation of the operating frame;
wherein the fulcrum shaft is pivotably supported by the clincher frame.

2. The stapler according to claim 1, further comprising:
a fulcrum spring for urging the fulcrum shaft in a direction of an end portion of a pivoting range.

3. The stapler according to claim 1, further comprising:
an elongated hole provided at the clincher frame and loosely fitted with the fulcrum shaft:

4. The stapler according to claim 2, further comprising:
an elongated hole provided at the clincher frame and loosely fitted with the fulcrum shaft.

5. The stapler according to claim 1, further comprising:
a strike mechanism portion for striking out a staple formed in a C-shape to sheets; and
a single electric motor;
wherein the movable clincher and the strike mechanism portion are operated based on driving the single electric motor.

6. The stapler according to claim 1, further comprising:
a table; and
a strike mechanism for striking out a staple to sheets arranged above the table;
wherein the clincher frame is supported to be able to be proximate and remote to and from the table.

7. The stapler according to claim 2, wherein a spring load of the fulcrum spring is set to a load compatible to a pertinent clinch load by the movable clincher.
